(19) United States
(12) Patent Application Publication
(10) Pub. No.: US 2018/0031458 A1
(43) Pub. Date: Feb. 1, 2018

(54) METHOD FOR TESTING THE BONDING STRENGTH OF ROCK BOLT-GROUT-SURROUNDING ROCK

(71) Applicant: Shandong University of Science and Technology, Qingdao (CN)

(72) Inventors: Yujing JIANG, Qingdao (CN); Xuezhen WU, Qingdao (CN); Gang WANG, Qingdao (CN); Shuchen LI, Qingdao (CN); Qi WANG, Qingdao (CN); Yue CAI, Qingdao (CN)

(21) Appl. No.: 15/658,339

(22) Filed: Jul. 24, 2017

(30) Foreign Application Priority Data
Jul. 26, 2016 (CN) 201610591595.1

(51) Int. Cl. G01N 3/24; G01N 19/04; G01B 11/25

(52) U.S. Cl. CPC G01N 3/24; G01B 11/2518; G01N 19/04; E21D 20/02

(57) ABSTRACT

The present method for testing the bonding strength of rock bolt-grout-surrounding rock comprises the following steps: step 1, fabricating the simulative body of a rock bolt provided with a first surface, wherein the concave-convex characteristic of the first surface is consistent with the surface appearance of a rock bolt, and the first surface is a plane; step 2, pouring a grout layer for simulating the grout material on the first surface of the simulative body of the rock bolt; step 3, pouring a surrounding rock layer for simulating the surrounding rock material on the solidified grout layer, wherein the simulative body of the rock bolt, the grout layer and the surrounding rock layer form a simulative anchoring body; and step 4, performing a shear test along the simulative stress direction of the simulative anchoring body to obtain mechanical parameters reflecting the bonding strength of the anchoring body.

### CROSS-REFERENCE TO RELATED APPLICATIONS

This application claims the benefit of priority under 35 U.S.C. § 119 from Chinese Patent Application No. 201610591595.1, filed Jul. 26, 2016. The disclosures of the foregoing application is incorporated herein by reference in its entirety.

### FIELD OF THE INVENTION

The present invention relates to the technical field of underground engineering, and in particular to a method for testing the bonding strength of rock bolt-grout-surrounding rock.

### BACKGROUND OF THE INVENTION

A rock bolt is one of main supporting forms of underground engineering and rock slopes and is a tension member which goes deep into the stratum. The technique thereof is to drill holes in a rock or soil layer, embedding rock bolts in the drilled holes and then pouring a grout into the drilled holes to fix the rock bolts in the rock (soil) layer of the slope or a tunnel so as to restrict the deformation damage to the rock (soil) layer and play a supporting role. The load acting on a supporting structure is born by the combined action of the bonding force between the grout of an anchoring segment of the rock bolt and the stratum, the bond stress of the rock bolt and the grout and the strength of the rock bolt itself, in order to maintain the stability of surrounding rock. In underground engineering, especially in case of deep excavation or water inrush, it is often necessary to accurately test the bonding strength of the anchoring body of the rock bolt. Therefore, it is very important to rationally determine the bonding strength of rock bolt-grout-surrounding rock.

In order to test the bonding strength of the rock bolt, a rock bolt pull-out test is mainly used in the traditional method. A rock bolt is arranged in a rock bolt pull-out test device, concrete used for simulating the grout is arranged on the periphery of the rock bolt, and the bonding strength of the rock bolt and the grout is obtained by pulling out the rock bolt. The rock bolt on an engineering site is as shown in FIG. 1, and the bonding strength of the rock bolt is mainly determined by testing the bonding strength between the rock bolt 1 and grout 2.

The traditional test method has the following problems:

1. In the rock bolt pull-out test, a shear force surface of the rock bolt is a circular curved surface, and its shear stress is exponentially distributed along the longitudinal direction, as shown in FIG. 2. Since relevant parameters of the exponential distribution cannot be obtained, the distribution of the shear stress of the rock bolt can only be regarded as uniform distribution along the longitudinal direction to calculate the bonding strength of the rock bolt in actual operations, so the test result obtained by the traditional rock bolt pull-out test has a relatively larger error as compared with the actual situation.

2. Only the bonding strength between the rock bolt and the grout can be obtained by the traditional rock bolt pull-out test, and the stress condition between the grout and the surrounding rock cannot be reflected, therefore the bonding strength of the whole anchoring body under the interaction of the rock bolt-grout-surrounding rock cannot be reflected accurately.

### SUMMARY OF THE INVENTION

The objective of the present invention is to provide a method for testing the bonding strength of rock bolt-grout-surrounding rock to overcome the shortcomings of the prior art. Uniform distribution of shear stress of a bonding surface is achieved by unfolding an anchoring structure, the technical problems such as nonuniformity shear stress transmission and the like in a traditional rock bolt pull-out test are overcome, the mechanical parameters of an anchoring body under different conditions can be obtained accurately, and a scientific basis is provided for reasonable supporting design of underground engineering.

In order to achieve the above objective, the present invention adopts the following technical solutions:

A method for testing the bonding strength of rock bolt-grout-surrounding rock comprises the following steps:

step 1, fabricating the simulative body of a rock bolt provided with a first surface, wherein the concave-convex characteristic of the first surface is consistent with the surface appearance of the rock bolt, the first surface is an approximate plane, the simulative body of the rock bolt is prepared by using a template, and at least one inner surface of the template is consistent with the first surface in surface appearance;

step 2, pouring a grout layer for simulating a grout material on the first surface of the simulative body of the rock bolt;

step 3, pouring a surrounding rock layer for simulating a surrounding rock material on the solidified grout layer, wherein the simulative body of the rock bolt, the grout layer and the surrounding rock layer jointly form a simulative anchoring body; and

step 4, performing a shear test along the simulative stress direction of the simulative anchoring body to obtain the mechanical parameters reflecting the bonding strength of the surrounding rock anchoring body.

The simulative body of the rock bolt is used for simulating the rock bolt, the grout layer is used for simulating the grout, the concave-convex characteristic of the contact surface between the simulative body of the rock bolt and the grout layer corresponds to the concave-convex characteristic of the contact surface between the rock bolt and the grout, and thus the bond stress between the rock bolt and the grout can be reflected accurately.

Since the rock bolt is generally screw-thread steel, whose surface is uneven, and the concave-convex characteristic of the first surface is consistent with the surface appearance of the rock bolt, therefore the first surface is not a standard plane; however, the plane where the first surface is located is not a circular curved surface, but is an approximate plane, therefore the first surface is said to be an approximate plane.

Different from the traditional rock bolt pull-out test in which the form of the shear force surface is a circular curved surface, the shear force surface of the simulative anchoring body is a plane, therefore the shear stress is uniformly distributed along the bonding surface in the test process, accordingly the calculated average shear force is the actual shear force, the obtained test result satisfies the actual situation, and the obtained mechanical parameters of the bonding strength are more accurate.

The simulative anchoring body is an assembly jointly formed by the simulative body of the rock bolt, the grout layer and the surrounding rock layer, the shear breakage process of the anchoring body can be obtained by observing the shear dislocation between the layers in the shear test process, the weak stress link of the anchoring body is clarified, and the bonding strength of the whole anchoring body under the interaction of the rock bolt-grout-surrounding rock can be reflected accurately.

In step 1, the rock bolt is a supporting rock bolt used on an engineering site, and the surface appearance is obtained by scanning the surface of the supporting rock bolt by using a laser scanner. By adopting this manner, the surface appearance of the existing supporting rock bolt can be obtained on the premise of not breaking the supporting structure of the engineering site, and the bonding strength of the rock bolt is obtained, which is convenient and quick, and greatly reduces the cost for testing the bonding strength of the rock bolt.

The area of the first surface is the same as the area of the side wall of the simulative segment of the rock bolt, so that the simulative anchoring body can reflect the real bonding strength of the rock bolt in engineering support more accurately.

Further, the specific method for fabricating the simulative body of the rock bolt is as follows: transmitting the data of plane appearance to a 3D printer, printing a mold having the appearance of the first surface by the 3D printer, and fabricating the simulative body of the rock bolt by using the mold as the template. The surface appearance of the side wall is unfolded along a generatrix to form a plane to obtain the plane appearance, therefore corresponding conversion from the surface appearance of the side wall to the concave-convex characteristic of the first surface is realized, and as the mold is fabricated by using a 3D printer, the automation degree is high, and good convenience, quickness and accuracy are achieved, and the technical means is advanced.

Further, another specific method for fabricating the template is as follows: cutting out a test specimen of the rock bolt, rolling the test specimen of the rock bolt on a plastic material under a set pressure condition, making the surface appearance of the rock bolt on the surface of the plastic material, and fabricating the simulative body of the rock bolt by using the surface of the plastic material with the made surface appearance of the rock bolt as the template. The manner of fabricating the template by rolling the rock bolt on the plastic material is distinct in principle, simple and convenient, and low in cost.

In step 1, the simulative body of the rock bolt is rectangular, the appearance of the upper surface of the simulative body of the rock bolt is the same as the surface appearance, the side face and the lower surface of the simulative body of the rock bolt are smooth surfaces, and the material of the simulative body of the rock bolt is consistent with the material type of the rock bolt in the engineering site. The shape of the simulative body of the rock bolt is regular, thereby being convenient to fabricate and test. As the material of the simulative body of the rock bolt is consistent with the material type of the rock bolt in the engineering site, the test result is more accurate.

In step 2, the thickness of the grout layer is consistent with the thickness of the grout of the rock bolt in the engineering site, the thickness of the grout has certain correlation with the bonding strength of the anchoring body, and as the thickness of the grout layer is consistent with the thickness of the grout, the bonding strength of the anchoring body can be better simulated.

In step 4, the specific manner of the shear test is as follows: mounting the simulative anchoring body on a shear test machine, applying normal stress to the simulative anchoring body, keeping constant rigidity of the simulative anchoring body, and then applying a shear force to the simulative anchoring body to obtain a shear stress-shear displacement curve in the test process; and changing the normal stress, and performing multiple groups of tests so as to obtain a normal stress-peak shear stress relationship. According to the actual situation in which a confining pressure is applied by the rock bolt to a rock mass in actual engineering, the actual rigidity of the anchoring body in the surrounding rock is simulated by adjusting the normal stress, which is more scientific and accurate.

In step 4, the bonding strength parameters of the rock bolt are analyzed according to the relationship between shear stress-shear displacement curve and the normal stress-peak shear stress.

The present invention has the following beneficial effects:

The simulative body of the rock bolt is used for simulating the rock bolt, the grout layer is used for simulating the grout, the concave-convex characteristic of the contact surface between the simulative body of the rock bolt and the grout layer corresponds to the concave-convex characteristic of the contact surface between the rock bolt and the grout, and thus the bond stress between the rock bolt and the grout can be reflected accurately.

Different from the traditional rock bolt pull-out test in which the form of the shear force surface is a circular curved surface, the shear force surface of the simulative anchoring body is a plane, therefore the defect of nonuniformity distribution of the shear stress in the pull-out test is overcome, the shear stress is uniformly distributed along the bonding surface in the test process, accordingly the calculated average shear force is the actual shear force, the obtained test result is in consistent with the actual situation, and the obtained mechanical parameters of the bonding strength are more accurate.

The simulative anchoring body is the assembly jointly formed by the simulative body of the rock bolt, the grout layer and the surrounding rock layer, the shear breakage process of the anchoring body can be obtained by observing the shear dislocation between the layers in the shear test process, the weak stress link of the anchoring body is clarified, and the bonding strength of the whole anchoring body under the interaction of the rock bolt-grout-surrounding rock can be reflected accurately.

### BRIEF DESCRIPTION OF THE DRAWINGS

FIG. 1 is a schematic diagram of a rock bolt on an engineering site;

FIG. 2 is a stress distribution diagram of a traditional test rock bolt;

FIG. 3 is a schematic diagram of the method for unfolding the rock bolt;

FIG. 4 is a stress distribution diagram of the shear test specimen of a rock bolt;

FIG. 5 is a schematic diagram of the mold of the test specimen of a rock bolt; and

FIG. 6 is a sectional schematic diagram of a simulative anchoring body.

In the figures, the correspondence of reference numerals is shown as below: 1. rock bolt, 2. grout, 3. the test specimen of a rock bolt, 4. the shear specimen of a rock bolt, 5. mold, 6. grout layer, and 7. surrounding rock layer.

### DETAILED DESCRIPTION OF THE EMBODIMENTS

The present invention will be illustrated below in detail in combination with the accompanying drawings.

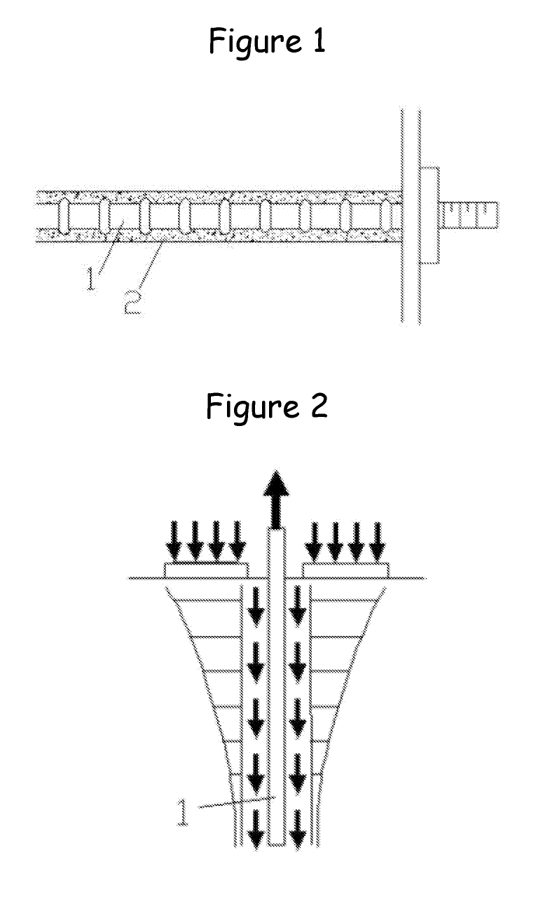

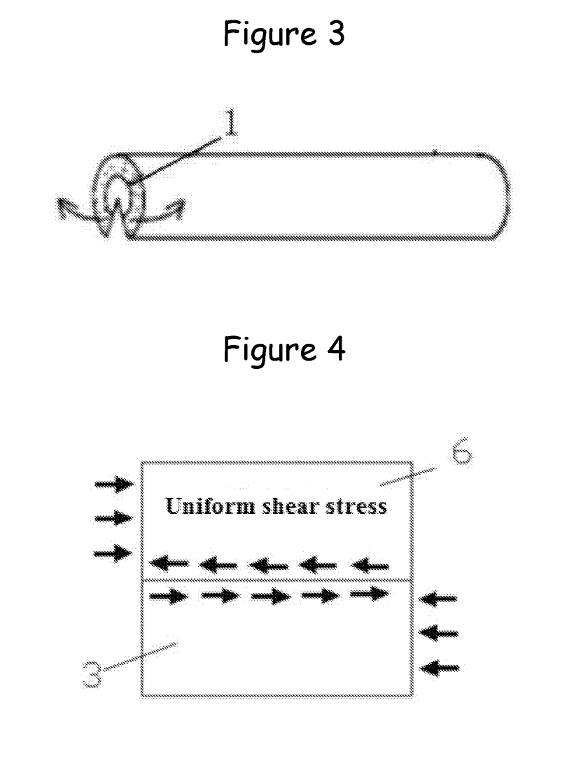

A rock bolt on an engineering site is as shown in FIG. 1, and the bonding strength of the rock bolt is mainly determined by testing the bonding strength between the rock bolt 1 and grout 2. The principle of the method for testing the bonding strength of rock bolt-grout-surrounding rock is as follows: in order to overcome the shortcomings of nonuniformity distribution of shear stress in a pull-out test, the rock bolt 1 is unfolded along the section as shown in FIG. 3, and fabricating a shear test specimen 3 of a rock bolt , a shear assembly 4 of rock bolt is obtained accordingly, the shear assembly 4 of the rock bolt is mounted on a shear test machine to perform a shear test, the distribution of the shear stress is uniform at present, as shown in FIG. 4, and the bonding strength parameters of the rock bolt 1 can be obtained according to an experimental curve.

### Embodiment 1

1. A method for testing the bonding strength of rock bolt-grout-surrounding rock comprises the following steps:

(1) taking a rock bolt used on an engineering site, and obtaining the data of the surface appearance of the rock bolt by scanning the surface of the rock bolt by using a laser scanner;

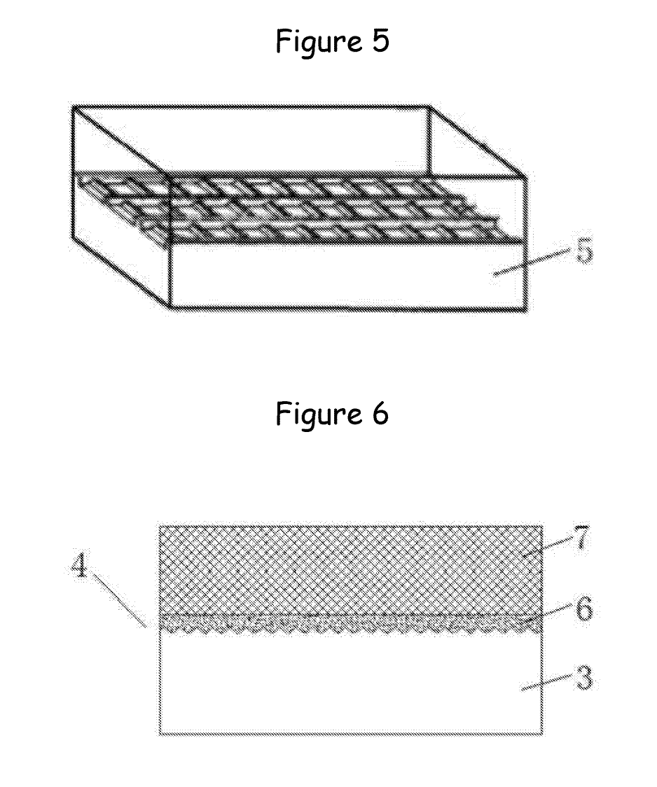

(2) transmitting the data of the surface appearance of the rock bolt to a 3D printer, and printing the mold 5 which has the surface appearance of the rock bolt and are used for fabricating the shear test specimen of a rock bolt 3 by using the 3D printer, as shown in FIG. 5;

(3) using the mold 5 as the template to fabricate the shear test specimen of a rock bolt 3, wherein the shear test specimen of a rock bolt 3 is rectangular on the whole, and the upper surface of the shear test specimen of the rock bolt has the same appearance as the surface of the rock bolt, and the side face and a lower surface of the shear test specimen of the rock bolt are smooth surfaces, and the adopted material is consistent with the material type of the rock bolt in the engineering site;

(4) with the shear test specimen of a rock bolt 3 as the template, pouring bonding material of a rock bolt on the shear test specimen 3 of the rock bolt to form a grout layer 6, wherein the thickness of the grout layer 6 is consistent with the thickness of the grout where the rock bolt in the engineering site, and pouring a rock-like material after the grout layer 6 is solidified to form a surrounding rock layer 7;

(5) jointly forming the shear specimen of a rock bolt 4 by the shear test specimen of a rock bolt 3, the grout layer 6 and the surrounding rock layer 7, mounting the shear specimen of a rock bolt 4 onto the shear test machine, firstly applying normal stress to the shear specimen of a rock bolt 4, keeping constant normal rigidity by servo control, then applying a shear force to the shear specimen of a rock bolt, shear dislocation is gradually generated between the shear test specimen of a rock bolt 3, the grout layer 6 and the surrounding rock layer 7 as the shear force continuously increases, and recording a shear stress-shear displacement curve in the whole test process; and

(6) analyzing the bonding strength parameters of the rock bolt according to the above-mentioned shear stress-shear displacement curve.

### Embodiment 2

(1) cutting out a segment of the rock bolt in the engineering site to serve as the test specimen of a rock bolt, rolling the rock bolt test specimen on a plastic material under a set pressure condition, and making the surface appearance of the rock bolt on the surface of the plastic material;

(2) fabricating the test specimen a rock bolt 3 by using the surface of the plastic material as the template, wherein the test specimen of a rock bolt 3 is rectangular on the whole, the upper surface of the test specimen of a rock bolt has the same appearance as the surface of the rock bolt, the side face and the lower surface of the test specimen of a rock bolt are smooth surfaces, and the adopted material is consistent with the material type of the rock bolt in the engineering site;

(3) with the test specimen of a rock bolt 3 as the template, pouring a rock bolt bonding material on the test specimen of a rock bolt 3 to form a grout layer 6, wherein the thickness of the grout layer 6 is consistent with the thickness of the grout where the rock bolt is in the engineering site, and pouring a rock-like material after the grout layer 6 is solidified to form a surrounding rock layer 7;

(4) jointly forming the shear specimen of a rock bolt 4 by the test specimen of a rock bolt 3, the grout layer 6 and the surrounding rock layer 7, mounting the shear specimen of a rock bolt 4 onto the shear test machine, firstly applying normal stress to the shear specimen of a rock bolt 4, keeping constant normal rigidity by servo control, then applying a shear force to the shear specimen of a rock bolt, shear dislocations are gradually generated among the test specimen of a rock bolt 3, the grout layer 6 and the surrounding rock layer 7 as the shear force continuously increases, and recording the shear stress-shear displacement curve in the whole test process;

(5) changing the above-mentioned normal stress, and performing multiple groups of tests so as to obtain the relationship between a normal stress-peak shear stress; and

(6) analyzing the bonding strength parameters of the rock bolt according to the relationship between shear stress-shear displacement curve and the normal stress-peak shear stress.

The foregoing description of the disclosed embodiments will enable those skilled in the art to implement or use the present invention. Various modifications to the embodiments will be apparent to those skilled in the art, and the general principles defined herein may be embodied in other embodiments without departing from the spirit or scope of the present invention. The parts which are not described in detail are the prior art and are not repeated redundantly herein. Accordingly, the present invention will not be limited to these embodiments shown herein, but needs to satisfy the widest scope consistent with the principles and features disclosed herein.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure.

Recitation of value ranges herein is merely intended to serve as a shorthand method for referring individually to each separate value falling within the range. Unless otherwise indicated herein, each individual value is incorporated into the specification as if it were individually recited herein. All references cited herein are incorporated by reference in their entirety.

1. A method for testing the bonding strength of rock bolt-grout-surrounding rock, comprising the following steps:
(1) fabricating the simulative body of the rock bolt provided with a first surface, wherein the concave-convex characteristic of the first surface is consistent with the surface appearance of the rock bolt, the first surface is an approximate plane, the simulative body of the rock bolt is prepared by using a template, and at least one inner surface of the template is consistent with the first surface in surface appearance;
(2) pouring a grout layer for simulating a grout material on the first surface of the simulative body of the rock bolt;
(3) pouring a surrounding rock layer for simulating a surrounding rock material on the solidified grout layer, wherein the simulative body of the rock bolt, the grout layer and the surrounding rock layer jointly form the shear specimen of the rock bolt; and
(4) performing a shear test along a simulative stress direction of the shear specimen of the rock bolt to obtain the mechanical parameters reflecting the bonding strength of the anchoring body.

2. The method for testing the bonding strength of rock bolt-grout-surrounding rock of claim 1, wherein in step (1), the rock bolt is a supporting rock bolt used on an engineering site, and the surface appearance is obtained by scanning the surface of the rock bolt by using a laser scanner.

3. The method for testing the bonding strength of rock bolt-grout-surrounding rock of claim 1, wherein the area of the first surface is the same as the area of the side wall of the simulative segment of the rock bolt.

4. The method for testing the bonding strength of rock bolt-grout-surrounding rock of claim 1, wherein the data of the surface appearance of the rock bolt are transmitted to a 3D printer, a mold having the surface appearance of the first surface is printed by the 3D printer, and the mold is used as the template to fabricate the simulative body of the rock bolt.

5. The method for testing the bonding strength of rock bolt-grout-surrounding rock of claim 2, wherein the data of the surface appearance of the rock bolt are transmitted to a 3D printer, a mold having the surface appearance of the first surface is printed by the 3D printer, and the mold is used as the template to fabricate the simulative body of the rock bolt.

6. The method for testing the bonding strength of rock bolt-grout-surrounding rock of claim 3, wherein the data of the surface appearance of the rock bolt are transmitted to a 3D printer, a mold having the surface appearance of the first surface is printed by the 3D printer, and the mold is used as the template to fabricate the simulative body of the rock bolt.

7. The method for testing the bonding strength of rock bolt-grout-surrounding rock of claim 1, wherein the specific method for fabricating the template is as follows:
cutting out a test specimen of the rock bolt, rolling the test specimen of the rock bolt on a plastic material under a set pressure condition, making the surface appearance of the rock bolt on the surface of the plastic material, and fabricating the simulative body of the rock bolt by using the surface of the plastic material with the made surface appearance of the rock bolt as the template.

8. The method for testing the bonding strength of rock bolt-grout-surrounding rock of claim 3, wherein the specific method for fabricating the template is as follows:
cutting out a test specimen of the rock bolt, rolling the test specimen of the rock bolt on a plastic material under a set pressure condition, making the surface appearance of the rock bolt on the surface of the plastic material, and fabricating the simulative body of the rock bolt by using the surface of the plastic material with the made surface appearance of the rock bolt as the template.

9. The method for testing the bonding strength of rock bolt-grout-surrounding rock of claim 1, wherein in step (1), the simulative body of the rock bolt is rectangular, the appearance of the upper surface of the simulative body of the rock bolt is the same as the surface appearance of rock bolt, the side face and the lower surface of the simulative body of the rock bolt are smooth surfaces, and the material of the simulative body of the rock bolt is consistent with the material type of the rock bolt in the engineering site.

10. The method for testing the bonding strength of rock bolt-grout-surrounding rock of claim 1, wherein in step (2), the thickness of the grout layer is consistent with the thickness of the grout where the rock bolt is in the engineering site.

11. The method for testing the bonding strength of rock bolt-grout-surrounding rock of claim 1, wherein in step (4), the specific manner of the shear test is as follows:
mounting the shear specimen of the rock bolt into a shear test machine, applying normal stress to the shear specimen of the rock bolt, keeping constant rigidity of the shear specimen of the rock bolt, and then applying the shear force to the shear specimen of the rock bolt to obtain a shear stress-shear displacement curve in the test process.

12. The method for testing the bonding strength of rock bolt-grout-surrounding rock of claim 11, wherein step (4) further comprises changing the normal stress and performing multiple groups of tests so as to obtain the relationship between the normal stress and peak shear stress.

13. The method for testing the bonding strength of rock bolt-grout-surrounding rock of claim 12, wherein in step 4, the bonding strength parameters of the rock bolt are analyzed according to the relationship between the shear stress-shear displacement curve and the normal stress-peak shear stress.
